(19) United States
(12) Patent Application Publication
(10) Pub. No.: US 2014/0022659 A1
(43) Pub. Date: Jan. 23, 2014

(54) ELECTROSTATIC LIGHT ATTENUATION AND INFORMATIONAL CARRIER SYSTEM AND METHOD

(71) Applicant: ClingCro LLC, Huffman, TX (US)

(72) Inventor: Kurt M. GRAVES, Huffman, TX (US)

(21) Appl. No.: 13/917,754

(22) Filed: Jun. 14, 2013

Related U.S. Application Data
(60) Provisional application No. 61/673,729, filed on Jul. 20, 2012.
(60) Provisional application No. 61/701,577, filed on Sep. 14, 2012.

(51) Int. Cl. G02B 5/20

(52) U.S. Cl. CPC G02B 5/205
USPC 359/888; 156/326

(57) ABSTRACT

An apparatus and method for attenuating light transmitted through a surface. The apparatus may include a light attenuator comprised of a substrate and an electrostatic layer. The electrostatic layer may be configured to electrostatically couple with the surface. The electrostatic layer may also electrostatically couple with the substrate. The substrate, the electrostatic layer or layers, or a light attenuating substance combined with at least one of the substrate and the electrostatic layer may attenuate light transmitted through the surface. The method may include positioning the light attenuator on the surface between the light source and the light receiver.

### CROSS REFERENCE TO RELATED APPLICATIONS

This application claims the benefit of Provisional U.S. Patent Application No. 61/673,729, filed Jul. 20, 2012, and Provisional U.S. Patent Application No. 61/701,577, filed Sep. 14, 2012.

### STATEMENT REGARDING FEDERALLY FUNDED RESEARCH AND DEVELOPMENT

The invention described in this patent application was not the subject of federally sponsored research or development.

### BACKGROUND OF THE DISCLOSURE

1. Field of the Disclosure

This disclosure generally relates to the field of light attenuation, and, in particular, to reducing light levels as a form of shading and in addition, providing communications, such as an apparatus for advertising.

2. Description of the Art

Generally, light attenuation sheets, such as sun shades, are coupled to a desired surface (windows, sheet glass, etc.) that is interposed between the sun and the object to be shaded (person, plants, etc.) The coupling of the sun shade to the desired surface often involves the application of an adhesive or suction. These couplings may have varying degrees of permanence, from an adhesive bond that is intended to remain months or years (window tinting) to removable in a few seconds (suction cup mounted sun shade). However, these coupling mechanisms have their drawbacks. Adhesives tend to resulting in a relatively permanent attachment of the sun shade to the desired surface that results in difficulty when repositioning or changing location of the sun shade is desired. Further, removal of the sun shade often results in an adhesive residue being left behind on the desired surface, which may reduce the visibility and clarity and may impair or make recoupling with the desired surface difficult. Also, adhesives may result in the tearing or deforming of the sun shade during the removal or repositioning process, which reduces the operational condition and lifetime of the sun shade. Non-adhesive sun shades may use point attachments, such as suction cups. These point attachments may be difficult to manipulate, fail to provide adequate coupling to the surface, deform when force is applied pull the suction cups from the surface, and result in reduced visibility since the sun shade may be separated from the desired surface by a height dimension of the suction cup.

### BRIEF SUMMARY OF THE DISCLOSURE

In aspects, the present disclosure is related to an apparatus and method for light attenuation. Specifically, the present disclosure is related to a multilayer attenuation sheet configured to electrostatically couple with a surface.

One embodiment according to the present disclosure includes an apparatus for attenuating light transmitted through a surface, the apparatus comprising: a form retaining substrate; and an electrostatic layer coupled to the form retaining substrate and configured to electrostatically couple with the surface, wherein at least part of one of the form retaining substrate and the electrostatic layer comprises a light attenuating substance.

Another embodiment according to the present disclosure includes a method for attenuating light transmitted through a surface, the method comprising: electrostatically coupling a light attenuator to the surface between a light source and a light receiver, wherein the light attenuator comprises: a form retaining substrate; and an electrostatic layer coupled to the form retaining substrate and configured to electrostatically couple with the surface, wherein at least part of one of the form retaining substrate and the electrostatic layer comprises a light attenuating substance.

Another embodiment according to the present disclosure includes an apparatus for attenuating light transmitted through a surface, the apparatus comprising: an electrostatic layer or layers configured to electrostatically couple with the surface; and a form retaining substrate coupled to the electrostatic layer and configured to reduce flexibility of the electrostatic layer, wherein at least part of one of the form retaining substrate and the electrostatic layer comprises a light attenuating substance.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a light attenuator deployed on a surface according to one embodiment of the present disclosure;

FIG. 2 shows a side view of the light attenuator of FIG. 1;

FIG. 3 shows a side view of a light attenuator with an adhesive layer between the substrate and the electrostatic layer according to one embodiment of the present disclosure;

FIG. 4 shows a light attenuator with optional notch and tab features according to one embodiment of the present disclosure;

FIG. 5 shows a flow chart of a method for attenuating light using an embodiment of the present disclosure; and

FIG. 6 shows a flow chart of a method for manufacturing the light attenuator of FIG. 1 according to one embodiment of the present disclosure.

### DETAILED DESCRIPTION OF THE DISCLOSURE

Generally, the present invention involves a method and apparatus for light attenuation, specifically involving electrostatic bonding for coupling the apparatus to a surface. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

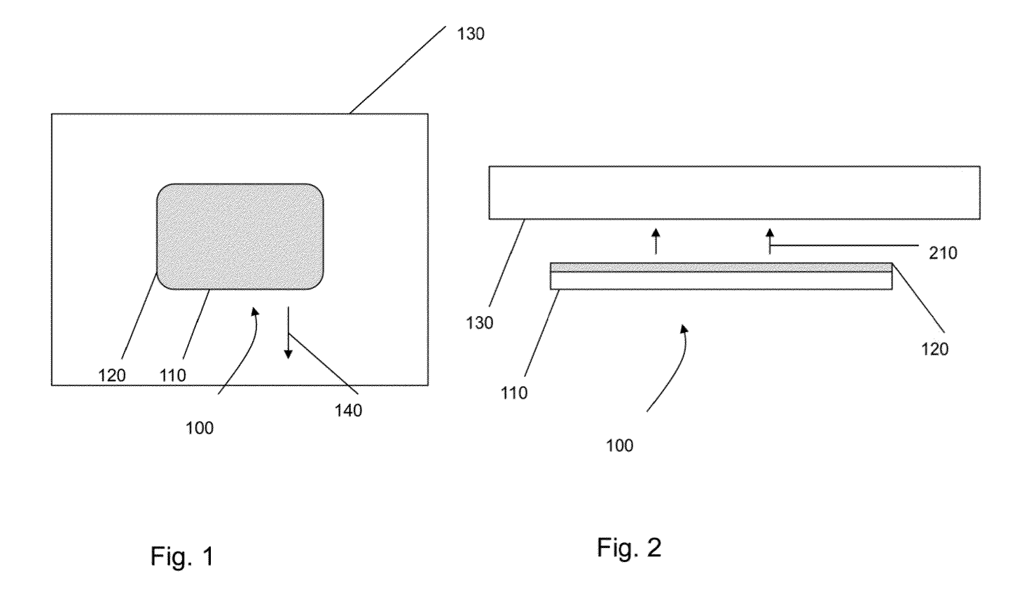

FIG. 1 Shows an apparatus for light attenuation according to one embodiment of the present disclosure. Herein, attenuation refers to any decrease in light amplitude including reductions due to absorption, reflection, and refraction. The light attenuator 100 may include a form retaining substrate 110 and an electrostatic layer 120. The substrate 110 may be rigid, resilient, and/or moldable. The substrate 110 may be form retaining in that the substrate 110 is configured to substantially retain its operational shape when not supported against gravitational force. The electrostatic layer 120 may be coupled to the substrate 110 by electrostatic force. The electrostatic layer 120 may be configured to be removed from or repositioned along the surface 130 without leaving a residue. The electrostatic layer 120 may include as film and may be non-form retaining (not retaining its form against gravitational force). The form retaining properties of the substrate 110 may provide structural support for the electrostatic layer 120. The electrostatic layer 120 may include as polyvinyl chloride resin and a plasticizer. The electrostatic layer 120 may include polyvinyl chloride film, such as a static cling film or low density polyethylene (LDPE). Although not shown, dual electronic layers 120 may be coupled on either sides of the substrate 110.

Discussing the light attenuator 100 in greater detail, in some embodiments, the substrate 110 may include a plastic, such as, but not limited to, a polycarbonate, a polyethylene, a polystyrene, a vinyl or a polypropylene. In some embodiments, the substrate 110 may include one or more of: i) glass, ii) polycarbonate, iii) plexiglass. The electrostatic layer 120 may be configured to electrostatically couple to a surface 130 to which the light attenuator 109 is to be applied. In some embodiments, the substrate 110 and the electrostatic layer 120 may be dimensioned such that the electrostatic force between the light attenuator 100 and the surface 130 is sufficient to hold the light attenuator in place on the surface 130 against slippage due to gravitational force 140 (denoted by a force vector) and other incidental forces (airflow, etc.). In some embodiments, the surface 130 may be substantially non-porous to increase the electrostatic force per surface area between the surface 130 and the light attenuator 100. The light attenuator 100 may be configured to be coupled with any substantially non-porous surface, including, but not limited to, one or more of: i) glass, ii) plastic, iii) metal, and iv) a ceramic. In some embodiments, light attenuator 190 may be configured to be coupled with a smooth, high gloss surface.

FIG. 2 shows a side view of the embodiment of FIG. 1. The electrostatic force between the electrostatic layer 120 and the surface 130 is shown with arrows 210. This electrostatic force 210 may be in a direction identical to or non-identical to the gravitational force 140. As shown, gravitation force 140 in FIG. 1 is perpendicular to electrostatic force 210. In some embodiments, the light attenuator 100 and/or individual components 110, 120 may be dimensioned so the electrostatic force 210 is sufficient to overcome gravitational force 140 regardless of the orientation of surface 130 relative to gravitational force 140.

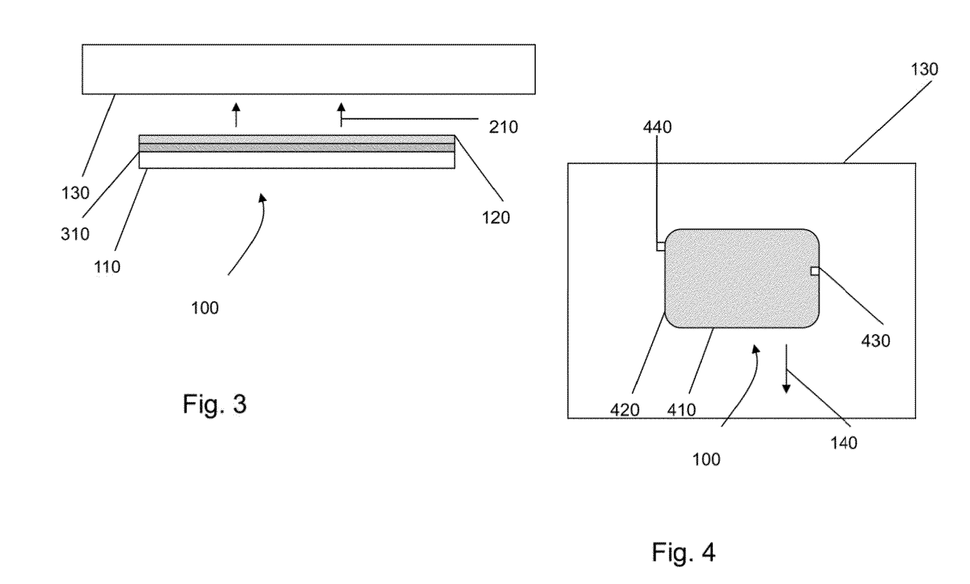

FIG. 3 shows a side view of another embodiment according to the disclosure. Here, light attenuator 100 includes an optional adhesive layer 310 between the electrostatic layer 120 and substrate 110. The adhesive layer 310 may be configured to enhance the electrostatic attraction on between substrate 110 and the electrostatic layer 120. The adhesive layer 310 may be configured to bond the substrate 110 to the electrostatic layer 120 where there is no or insufficient electrostatic force between substrate 110 and electrostatic layer 120. This insufficient electrostatic force may be due one or more of: i) the composition of the substrate and ii) the anticipated attractive force between the electrostatic layer 120 and surface 130. Adhesive layer 310 may be partially or completely co-terminus with the overlap between the electrostatic layer 120 and the substrate 110.

The light attenuator 100 is configured to attenuate light at at least one frequency. Herein, the term “light” generally covers electromagnetic radiation (visible, infra-red, ultraviolet, etc.). Each of the layers (substrate 110, electrostatic layer 120, and adhesive 310) may be selected for the ability to attenuate at least one frequency of light. In some embodiments, additives to one or more of the layers 110, 120, 310, may provide attenuation properties for one or more of the layers 110, 120, 310. The additives may include, but are not limited to, chemical dyes. In some embodiments, attenuation may be a result of etching, or deposition in or on one or more of the layers 110, 120, 310. In some embodiments, each of the layers may be configured to attenuate light over identical or non-identical frequency ranges. In some embodiments, only part of one or more of the layers 110, 120, 310, may be configured to attenuate light at selected frequencies. Herein, attenuation of light includes reducing the intensity of incoming light to a level below one hundred percent of the light's incoming intensity, including reducing the light intensity to zero percent. This selective light attenuation enables the light attenuator 100 to be used to display symbols and/or images, such as in signage, decals, masking, print, window graphics, and other types of displays that would be known to one of ordinary skill of the art with the benefit of this disclosure. In some embodiments the light attenuator 100 may be shaped into a symbol or image, such as an alphanumeric character. The embodiments may include shapes that form one or more of: words, letters, symbols, pictures, cut outs, an advertisement such as a company's name/address or logo, and information, such as “Open” or “Closed” or warning signs. The advertisement or information may be printed on the electrostatic layer 120 by basic print equipment known to one of skill in the art.

Another embodiment consists of a two-sided signage. Words, letters, symbols, pictures, cut outs, advertisement such as a company's name/address or logo, or information, such as “Open” or “Closed” or warning signs may be printed on both sides of the light attenuator 100. In some embodiments, one or both of the electrostatic layer 120 and substrate 110 may be opaque or translucent such that the embodiment may display information on both sides of the light attenuator 100 (dual-sided signage). In some embodiments, an additional electrostatic layer (not shown) may be added to the light attenuator 100 in contact with the substrate 110 such that both sides of the light attenuator are configured to be coupled to the surface 130. The additional electrostatic layer may include words, letter, symbols, pictures, cut outs, advertisement, information, or a logo for form dual-sided signage.

FIG. 4 shows another embodiment of the light attenuator 100, however, this time the electrostatic layer 420 is not fully overlapping with substrate 410. The non-overlapping area may include a notch 430. This notch 430 is an area of the light attenuator 100 where the substrate 410 is present but the electrostatic layer 420 is not. Due to the absence of the electrostatic layer 420 in the notch 430, the electrostatic force between notch 430 and surface 130 will be substantially less than the electrostatic force between the electrostatic layer 420 and the surface 130. This area of reduced electrostatic force is configured so that a person may more easily remove or reposition the light attenuator 100 relative to the surface 130. While the notch 430 is shown along one side of the light attenuator 100, this position is exemplary and illustrative only, as the notch 430 may be located anywhere on the light attenuator 100. In some embodiments, a tab 440 may be coupled to one or more of the substrate 410 and electrostatic layer 420 and configured to allow the light attenuator 100 to be pulled free of or repositioned along the surface 130. The tab 440 may be used instead of or in addition to notch 430. The tab 440 may have a composition that is identical or non-identical to the substrate 410.

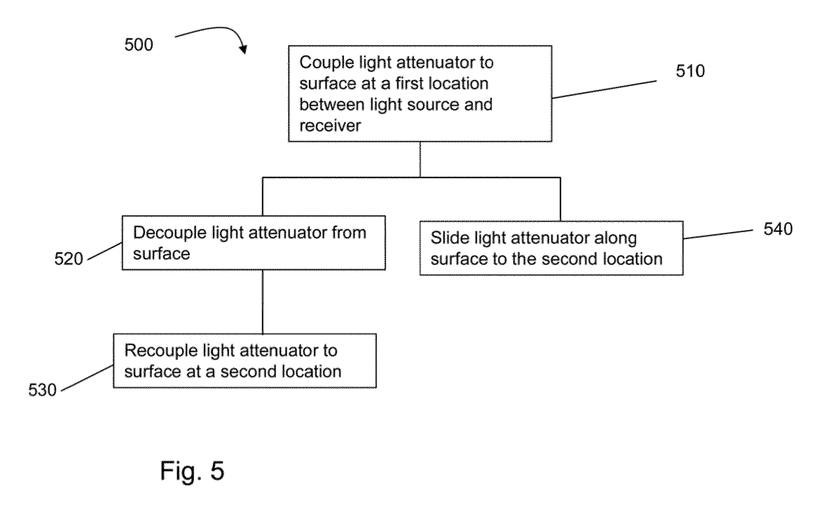

FIG. 5 shows a flow chart of a method 500 according to one embodiment of the pending disclosure. In step 510, the light attenuator 100 may be positioned on a surface at a first location, which may be between a light source and a receiver. The receiver may be any entity capable of detecting light, including, but not limited to, optical sensors, radiation sensor, and human eyes. In step 520, the light attenuator 100 may be decoupled from the surface 130. In step 530, the light attenuator 100 may be recoupled to the surface 130 at a second location. In some embodiments, step 530 may be optional.

Alternatively, step 510 may proceed to step 540. In step 540, sufficient force may be applied to the light attenuator 100 to slide the light attenuator from the first location to the second location along the surface 130 while a suitable amount of electrostatic force is maintained between the electrostatic layer 120 and the surface 130 so that the light attenuator 100 and the surface substantially remain in contact with one another (electrostatic force 140 is not fully overcome, as in decoupling). In some embodiments, the movement from the first location of either method described above may include the person or device causing the movement to securely grasp the light attenuator 100 by one or more of: i) the substrate 110, the optional notch 430, and the optional tab 440.

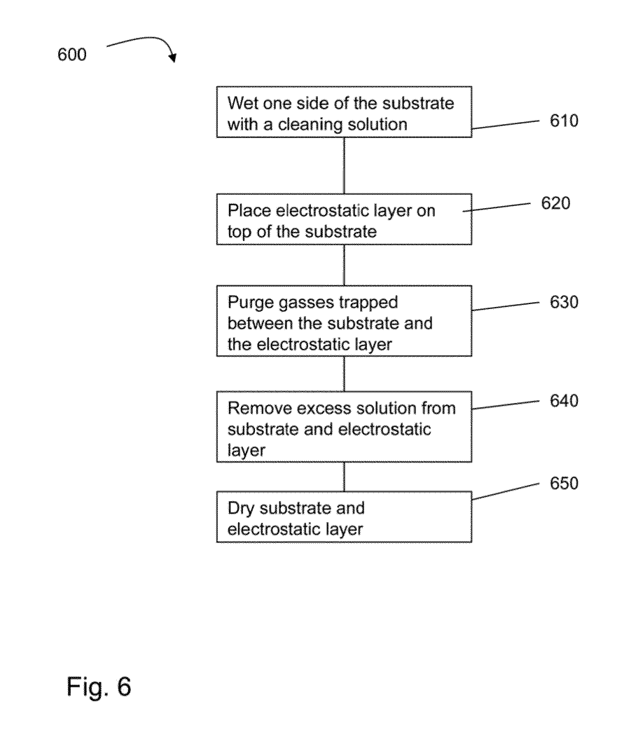

FIG. 6 shows an exemplary method 600 of manufacturing the light attenuator 100 according to one embodiment of the disclosure. In step 610, one side of the substrate 110 may be wetted with a solution. The solution may include a mixture of water and a detergent. The wetting process may include spraying. In step 620, the electrostatic layer 120 may be placed on top of the wetted side of the substrate 110. In step 630, purge air or trapped gasses from between the substrate 110 and the electrostatic layer 120. Purging may include applying pressure to smooth one or both of the substrate 110 and the electrostatic layer 120. In step 640, excess solution may be removed, if necessary, from the substrate 110 and the electrostatic layer 120. In step 650, the light attenuator 100 may be allowed to dry for a specified period of time. The drying time may vary based on environmental conditions as understood by one of ordinary skill in the art with the benefit of this disclosure.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

While the foregoing disclosure is directed to the one mode embodiments of the disclosure, various modifications will be apparent to those skilled in the art. It is intended that all variations within the scope of the appended claims be embraced by the foregoing disclosure.

What is claimed is:

1. An apparatus for attenuating light transmitted through a surface, the apparatus comprising:
a form retaining substrate; and
an electrostatic layer coupled to the first layer and configured to electrostatically couple with the surface, wherein at least one of the form retaining substrate and the electrostatic layer includes a light attenuating substance.

2. The apparatus of claim 1, wherein the form retaining substrate comprises at least one of: i) a glass, ii) a plastic, etc.

3. The apparatus of claim 1, wherein the form retaining substrate comprises polycarbonate.

4. The apparatus of claim 1 wherein the form retaining substrate is at least one of: i) rigid, ii) resilient, and iii) moldable.

5. The apparatus of claim 1, wherein the electrostatic layer comprises polyvinyl chloride film.

6. The apparatus of claim 1, wherein the surface is substantially non-porous.

7. The apparatus of claim 1, wherein the bond between the substrate and the electrostatic layer is at least one of: i) an electrostatic bond and ii) an adhesive bond.

8. The apparatus of claim 3, further comprising a second electrostatic layer, wherein the substrate has a first side and a second side and the first electrostatic layer is coupled to the first side and the second electrostatic layer is coupled to the second side.

9. A method for attenuating light transmitted through a surface, the method comprising:
electrostatically coupling a light attenuator to the surface between a light source and a light receiver, wherein the light attenuator comprises:
a form retaining substrate; and
an electrostatic layer coupled to the form retaining substrate and configured to electrostatically couple with the surface, wherein at least part of one of the form retaining substrate and the electrostatic layer comprises a light attenuating substance.

10. The method of claim 9, further comprising:
moving the light attenuator from a first position on the surface to a second position on the surface.

11. The method of claim 10, wherein moving the light attenuator from the first position to the second position includes one of: i) sliding the light attenuator along the surface and ii) decoupling the light attenuator from the surface in the first position and recoupling the light attenuator at the second position.

12. The method of claim 9, wherein the form retaining substrate comprises at least one of: i) a glass, ii) a plastic, etc.

13. The method of claim 9, wherein the form retaining substrate comprises polycarbonate.

14. The method of claim 9 wherein the form retaining substrate is at least one of: i) rigid, ii) resilient, and iii) moldable.

15. The method of claim 9, wherein the electrostatic layer comprises polyvinyl chloride film.

16. The method of claim 9, wherein the surface is substantially non-porous.

17. An apparatus for attenuating light transmitted through a surface, the apparatus comprising:
an electrostatic layer configured to electrostatically couple with the surface; and
a form retaining substrate configured to couple with the electrostatic layer and reduce flexibility of the electrostatic layer, wherein at least one of the form retaining substrate and the electrostatic layer comprises light attenuating substance.

18. A method of manufacturing a light attenuator configured to electrostatically couple with a surface and comprising a form retaining substrate and an electrostatic layer, the method comprising:
wetting a side of the form retaining substrate with an aqueous detergent solution;
positioning the electrostatic layer in contact with the wetted side; and
purging trapped gasses from between the form retaining substrate and the electrostatic layer.

19. The method of claim 19, further comprising:
drying the form retaining substrate and electrostatic layer.

20. The method of claim 19, wherein purging the trapped gasses comprises:
applying pressure to at least one of the form retaining substrate and the electrostatic layer.

21. The method of claim 20, wherein at least one of the electrostatic layer and the substrate includes a printed advertisement.
